(19) United States
(12) Patent Application Publication
(10) Pub. No.: US 2024/0395454 A1
(43) Pub. Date: Nov. 28, 2024

(54) MAGNETIC CORE CONSIDERING SKIN EFFECT OF MAGNETIC FLUX AND DESIGN METHOD THEREOF

(71) Applicant: Southeast University, Jiangsu (CN)

(72) Inventors: Ming CHENG, Jiangsu (CN); Wei QIN, Jiangsu (CN); Xinkai ZHU, Jiangsu (CN); Wei HUA, Jiangsu (CN); Zheng WANG, Jiangsu (CN); Sa ZHU, Jiangsu (CN); Zhiyuan XU, Jiangsu (CN)

(21) Appl. No.: 18/261,957

(22) PCT Filed: Feb. 14, 2023
(86) PCT No.: PCT/CN2023/075827

§ 371 Date: Jul. 18, 2023

(30) Foreign Application Priority Data
Sep. 5, 2022 (CN) 202211080070.3

(51) Int. Cl. H01F 27/34; H01F 27/24

(52) U.S. Cl. CPC H01F 27/34; H01F 27/24

(57) ABSTRACT

According to a magnetic core considering the skin effect of magnetic flux and a design method thereof, with a cross-section of a magnetic core through which magnetic flux flows as a reference surface, the shape of the cross-section of the magnetic core is designed according to the electromagnetic characteristics, temperature characteristics, magnetic flux amplitude and operating frequency of the magnetic core, and a closed or discontinuous air path is formed inside the magnetic core by stretching the reference surface along the path of the magnetic flux, thereby forming a magnetic core having a duct structure. When a high-frequency magnetic flux is introduced into the magnetic core, the magnetic core considering the skin effect of magnetic flux and the design method thereof can reduce the weight of the magnetic core, reduce the power loss and temperature rise of the magnetic core, and suppress the skin effect of the magnetic core.

### TECHNICAL FIELD

The present invention relates to the field of application of magnetic circuit theory, and in particular relates to magnetic core design.

### BACKGROUND

Consistent with the way a conductor conducts a current in an electrical circuit, the purpose of using a magnetic core in a magnetic circuit is to provide a predictable, well-defined path for a magnetic flux and to concentrate the magnetic field energy in the magnetic core. When the magnetomotive force is constant, the magnetic circuit constructed by the magnetic core can reduce the reluctance of the magnetic circuit and increase the magnetic flux of the magnetic circuit. The existence of the magnetic core not only improves the magnetic energy density of an electromagnetic device, but also reduces the size and weight of the electromagnetic device.

From the “Transformer and Inductor Design Handbook” (Fourth Edition) translated by Zhou Jinghua and Gong Shaowen, structures of magnetic cores are divided into core type and shell type according to the positional relationship between magnetic cores and coils. At present, many domestic and foreign magnetic core manufacturers, such as TDK Corporation in Japan, Ferroxcube Corporation in America, and New Conda Corporation in China, further divide magnetic cores into ring type, CC or UU type, tank type, PQ type, RM type, EE type, etc. The magnetic cores are varied in shape, and have their corresponding choices according to different applications. Various magnetic cores can be combined to form a closed or non-closed magnetic circuit.

When an alternating current is introduced into a conductor, the equivalent inductance inside the conductor causes an uneven current distribution in the conductor, where the current is concentrated in the “skin” part of the conductor, that is to say, the current is concentrated in a thin layer of the outer surface of the conductor, and the closer to the surface of the conductor, the greater the current density, and the current inside the conductor is actually small. As a result, the resistance of the conductor increases, which causes the power loss thereof to increase as well. This phenomenon is called the skin effect of current. From Chinese patent CN202011350276.4, there is not only a reluctance parameter but also a magductance parameter in the magnetic circuit. When an alternating magnetic flux is introduced into the magnetic core, due to the existence of the magductance parameter in the magnetic circuit, the magnetic flux in the magnetic core may exhibit the skin effect, that is, a high-frequency magnetic flux is unevenly distributed in the magnetic core, and the magnetic flux tends to flow along the surface of the magnetic core, with the magnetic induction intensity gradually decreasing from the surface to the center. The skin effect of the magnetic core not only brings power loss, but also limits the ability of the magnetic core to conduct a high-frequency magnetic flux. However, the skin effect of magnetic flux is not considered in the existing magnetic core products and design methods thereof, resulting in much material use, heavy weight and high power loss.

### SUMMARY

The technical problem to be solved by the present invention is that, for the defects of the background technology, a magnetic core considering the skin effect of magnetic flux and a design method thereof are proposed. According to the method, with a cross-section of a magnetic core through which magnetic flux flows as a reference surface, the shape of the cross-section of the magnetic core is designed according to the electromagnetic characteristics, temperature characteristics, magnetic flux amplitude and operating frequency of the magnetic core, and a closed or discontinuous air path is formed inside the magnetic core by stretching the reference surface along the path of the magnetic flux, thereby forming a magnetic core having a duct structure.

To solve the above technical problems, the present invention adopts the following technical solutions:

The present invention first proposes a magnetic core considering the skin effect of magnetic flux, wherein the magnetic core considering the skin effect of magnetic flux has a closed or discontinuous duct structure, with which the weight of the magnetic core can be reduced, and the loss and temperature rise of the magnetic core can be reduced. When a high-frequency magnetic flux is introduced into the magnetic core, the magnetic core has the effect of suppressing the skin effect of magnetic flux.

According to the magnetic core considering the skin effect of magnetic flux, under the premise that the outer contour of the magnetic core has been determined, a cross-section of the magnetic core characterized by a multi-connected region can be formed by designing the cross-section of the magnetic core through which the magnetic flux flows according to the electromagnetic characteristics, temperature coefficient, magnetic flux amplitude and operating frequency of the material of the magnetic core, where the cross-section of the magnetic core may be or may not be symmetrical about the center.

Further, according to the magnetic core considering the skin effect of magnetic flux, its cross-section may be designed into a hollow ring structure, or a radial notch structure, etc., to reduce or block the path of an induced eddy current, that is, to reduce the equivalent magductance of the magnetic circuit.

Further, according to the magnetic core considering the skin effect of magnetic flux, the shape of the closed or discontinuous duct inside the magnetic core may be obtained by stretching the cross-section of the magnetic core along the path through which the magnetic flux flows.

Further, according to the magnetic core considering the skin effect of magnetic flux, the thickness of the closed or discontinuous duct inside the magnetic core is determined by the electromagnetic characteristics, temperature coefficient, magnetic flux magnitude and operating frequency of the material of the magnetic core, that is, related to the skin depth

$$δ = \sqrt{\frac{1}{π f μ σ}}$$

of the magnetic flux. In the formula, f is the operating frequency of the magnetic flux in the magnetic core, u is the temperature-dependent magnetic conductivity of the magnetic core, and σ is the temperature-dependent electrical conductivity of the magnetic core.

Further, according to the magnetic core considering the skin effect of magnetic flux, the closed or discontinuous duct inside the magnetic core may be filled with air or other non-magnetic conductive materials. In particular, for the magnetic core internally having the continuous duct structure, the duct structure can be used as a circulation passage for a cooling medium, thus improving the cooling effect of the magnetic core.

Further, according to the magnetic core considering the skin effect of magnetic flux, the closed or discontinuous duct structure of the magnetic core reduces the value of the equivalent magductance of the magnetic circuit. From the power law of the magnetic circuit P=ω(ω [symbol] Φ²), under the condition of the same magnetic flux, the magnetic core can generate smaller magnetic core power loss and reduce the temperature rise of the magnetic core.

Further, according to the magnetic core considering the skin effect of magnetic flux, its material is a magnetic material capable of forming a magnetic circuit, such as silicon steel, nickel-iron (Permalloy), cobalt-iron (Permendur), amorphous metal alloys, and ferrites.

Further, according to the magnetic core considering the skin effect of magnetic flux, in order to adapt to different application requirements, the magnetic core internally has a closed or discontinuous duct structure, and has a shape which may be consistent with common magnetic core shapes, such as ring type, CC or UU type, tank type, PQ type, RM type and EE type.

The present invention also proposes a design method for a magnetic core considering the skin effect of magnetic flux, comprising the following specific steps:
S1. selecting the shape, size and material of the magnetic core according to actual application requirements;
S2. designing a cross-section of the magnetic core through which the magnetic flux flows according to the electromagnetic characteristics, temperature characteristics, magnetic flux amplitude and operating frequency of the magnetic core, to form a multi-connected region;
S3. stretching the cross-section of the magnetic core along the plane of the path for the magnetic flux to flow through the magnetic core, to form a continuous or discontinuous tubular structure inside the magnetic core; and
S4. forming a closed magnetic circuit by the magnetic cores or other media, thus forming the magnetic core considering the skin effect of magnetic flux.

Further, according to the design method for the magnetic core considering the skin effect of magnetic flux proposed by the present invention, in the step S1, the shape of the magnetic core includes, but not limited to, ring type, CC or UU type, tank type, PQ type, RM type and EE type. The material of the magnetic core includes, but not limited to, silicon steel, nickel-iron (Permalloy), cobalt-iron (Permendur), amorphous metal alloys, and ferrites.

Further, according to the design method for the magnetic core considering the skin effect of magnetic flux proposed by the present invention, in the step S4, since a single magnetic core cannot form a closed magnetic circuit, it needs to be combined with other magnetic cores or other media to form a closed magnetic circuit. Since the magnetic core in the magnetic circuit considers the skin effect of magnetic flux, the closed magnetic circuit has the effect of suppressing the skin effect of magnetic flux.

The present invention adopts the above technical solutions, and its beneficial effects over the prior art are that:
1. The proposed magnetic core considering the skin effect of magnetic flux has the closed or discontinuous duct structure, which saves the material for making the magnetic core and reduces the weight of the magnetic core.
2. Under the condition of generating the same alternating magnetic flux, the magnetic core considering the skin effect of magnetic flux requires less magnetomotive force at a high frequency.
3. The closed or discontinuous duct structure of the magnetic core can effectively reduce the value of the equivalent magductance of the closed magnetic circuit formed by the magnetic core, and under the same alternating magnetic flux, can effectively reduce the power loss of the magnetic core and the resulting temperature rise.
4. The closed or discontinuous duct structure of the magnetic core provides a circulation passage for a cooling medium of the magnetic core, which provides convenience for design of a magnetic core cooling system.

### BRIEF DESCRIPTION OF THE DRAWINGS

FIGS. 1A-1C are principle diagrams showing generation of the skin effect of magnetic flux according to the present invention.

FIGS. 2A-2D are schematic diagrams of different magnetic cores of a magnetic core considering the skin effect of magnetic flux and a design method thereof according to the present invention.

FIG. 3 is a flow chart of the magnetic core considering the skin effect of magnetic flux and the design method thereof according to the present invention.

FIG. 4 is an assembly diagram of the magnetic cores of the magnetic core considering the skin effect of magnetic flux and the design method thereof according to the present invention.

FIG. 5 is a verification device for the magnetic core considering the skin effect of magnetic flux and the design method thereof according to the present invention.

FIGS. 6A-6C are experimental results of the magnetic core considering the skin effect of magnetic flux and the design method thereof according to the present invention.

### DETAILED DESCRIPTION OF THE EMBODIMENTS

In order to make the objectives, technical solutions, and advantages of the present invention clearer, the technical solutions of the present invention are further described in detail below with reference to the accompanying drawings. It is obvious that specific embodiments described herein are only intended to explain the present invention instead of limiting the present invention.

One of ordinary skill in the art can understand that unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art, and will not be interpreted in an idealized or overly formal sense unless expressly so defined herein.

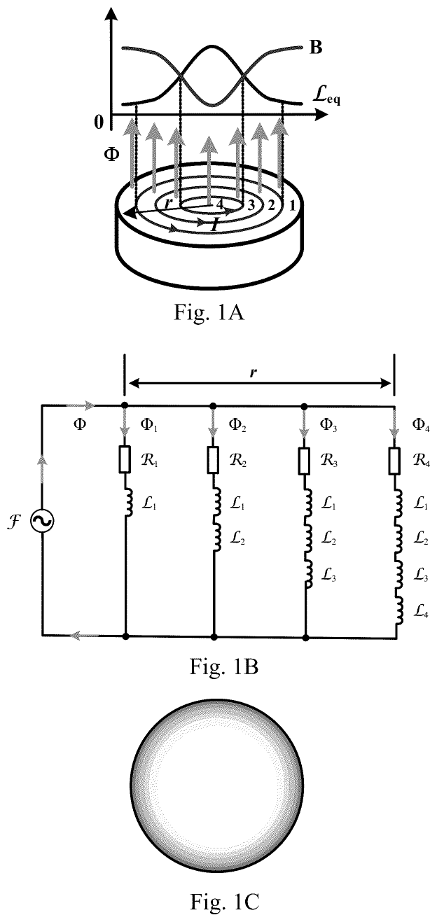

When an alternating magnetic flux is introduced into a magnetic circuit, the magductance in the magnetic circuit may generate an induced magnetomotive force (induced current) to hinder the change of the magnetic flux in the magnetic circuit, as shown in FIG. 1A. As the frequency of the alternating magnetic flux in the magnetic circuit increases, the magnetic flux may also have the skin effect, like the alternating current in the conductor. Here, a cylindrical magnetic core is used to analyze the cause of the skin effect of magnetic flux. As shown in FIG. 1A, for simplicity, the circular magnetic core is divided into four rings 1, 2, 3, and 4. From Faraday's law and Lenz's law, there are induced magnetomotive forces generated in all the four cross-sections. For the induced magnetomotive force in the magnetic core 1, the generated reverse magnetic flux not only hinders the change of the magnetic flux in the magnetic core 1, but also has an hindering effect on the magnetic fluxes in the magnetic cores 2, 3, and 4, that is, the magductance of magnetic core 1 also acts on the magnetic fluxes of magnetic cores 2, 3, and 4. According to the relationship between the magnetic core parts, an equivalent magnetic circuit diagram can be drawn as shown in FIG. 1B. It can be seen that the closer to the center of the magnetic core, the larger the value of the equivalent magductance in the branch, and the smaller the corresponding magnetic flux, while the closer to the surface, the smaller the value of the equivalent magductance in the branch, and the larger the corresponding magnetic flux, that is, the skin effect of magnetic flux occurs. As the frequency of the magnetic core further increases, the magnetic density distribution in the magnetic core is shown in FIG. 1C. It can be seen that all the magnetic flux flows in only a thin layer of the surface of the magnetic core, which not only brings more power loss but also increases magnetic core saturation, thus limiting the ability of the magnetic core to conduct a high-frequency magnetic flux.

In order to solve this problem of the skin effect of magnetic flux, the present invention proposes a magnetic core considering the skin effect of magnetic flux and a design method thereof, the core content of which is that with a cross-section of a magnetic core through which magnetic flux flows as a reference surface, the shape of the cross-section of the magnetic core is designed according to the electromagnetic characteristics, temperature characteristics, magnetic flux amplitude and operating frequency of the magnetic core, and a closed or discontinuous air path is formed inside the magnetic core by stretching the reference surface along the path of the magnetic flux, thereby forming a magnetic core having a duct structure.

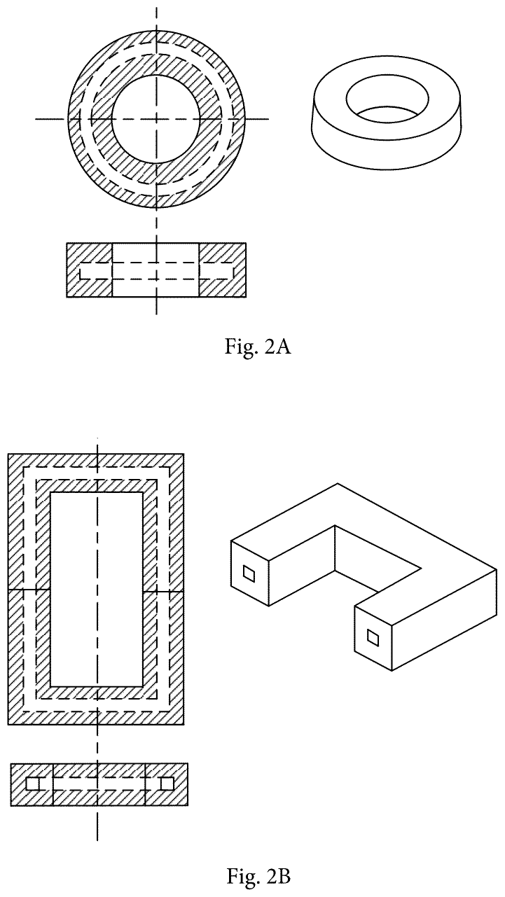

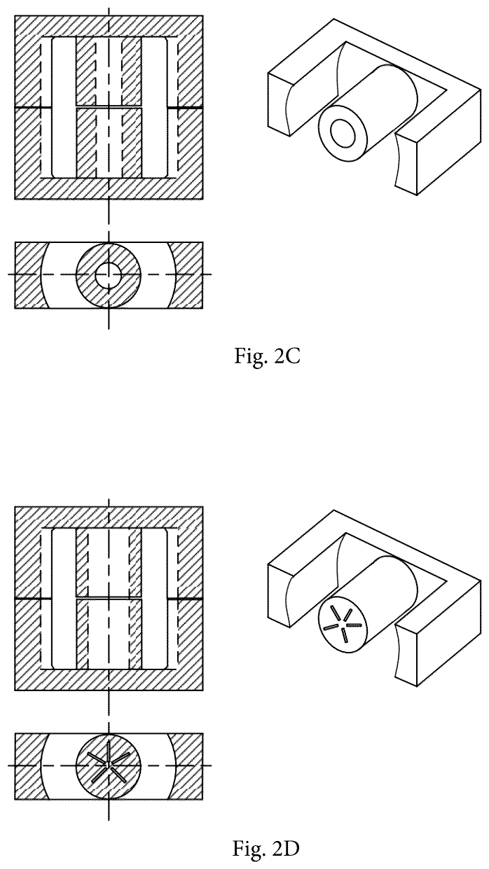

The magnetic core considering the skin effect of magnetic flux has a closed or discontinuous duct structure. The closed duct structure is shown in FIG. 2A and in FIG. 2B, and the discontinuous duct structure is shown in FIG. 2C and in FIG. 2D. When a high-frequency magnetic flux is introduced into the magnetic core, the duct structure can reduce the weight of the magnetic core, reduce the power loss and temperature rise of the magnetic core, and have the effect of suppressing the skin effect of the magnetic core.

According to the magnetic core considering the skin effect of magnetic flux, under the premise that the outer contour of the magnetic core has been determined, a cross-section of the magnetic core characterized by a multi-connected region can be formed by designing the cross-section of the magnetic core through which the magnetic flux flows according to the electromagnetic characteristics, temperature coefficient, magnetic flux amplitude and operating frequency of the material of the magnetic core, where the cross-section of the magnetic core may be symmetrical about the center, as shown in FIG. 2C, or may not be symmetrical about the center, as shown in FIG. 2D. The thickness of the closed or discontinuous duct inside the magnetic core is determined by the electromagnetic characteristics, temperature coefficient, magnetic flux amplitude and operating frequency of the material of the magnetic core, that is, related to the skin depth

$$δ = \sqrt{\frac{1}{π f μ σ}}$$

of the magnetic flux. In which formula, f is the operating frequency of the magnetic flux in the magnetic core, μ is the temperature-dependent magnetic conductivity of the magnetic core, and σ is the temperature-dependent electrical conductivity of the magnetic core. For example, when the frequency of the magnetic flux in the magnetic circuit is high, the skin depth of magnetic flux is small. At this time, the thickness of the duct can be appropriately reduced according to actual requirements.

Further, according to the magnetic core considering the skin effect of magnetic flux, its cross-section may be designed into a hollow ring structure, or a radial notch structure, etc., as shown in FIG. 2C and FIG. 2D, to reduce or block the path of an induced eddy current, that is, to reduce the equivalent magductance of the magnetic circuit.

Further, according to the magnetic core considering the skin effect of magnetic flux, the shape of the closed or discontinuous hollow duct inside the magnetic core may be obtained by stretching the cross-section of the magnetic core along the path through which the magnetic flux flows. When stretching continuously along the closed magnetic circuit, a magnetic core having a continuous duct structure can be obtained, as shown in FIG. 2A and FIG. 2B. When stretching discontinuously along the closed magnetic circuit, a magnetic core having a discontinuous duct structure can be obtained. For example, in FIG. 2C and FIG. 2D, the discontinuous duct structure is obtained by stretching the cross-section of the magnetic core along a central column path of the magnetic circuit.

Further, according to the magnetic core considering the skin effect of magnetic flux, the closed or discontinuous duct inside the magnetic core may be filled with air or other non-magnetic conductive materials. In particular, for the magnetic core internally having the continuous duct structure, the duct structure can be used as a circulation passage for a cooling medium, thus improving the cooling effect of the magnetic core.

Further, according to the magnetic core considering the skin effect of magnetic flux, the closed or discontinuous duct structure the magnetic core has reduces the value of the equivalent magductance of the magnetic circuit. From the power law of the magnetic circuit P=ω(ω [symbol] Φ²) under the condition of the same magnetic flux, the magnetic core can generate smaller magnetic core power loss and reduce the temperature rise of the magnetic core.

Further, according to the magnetic core considering the skin effect of magnetic flux, its material is a magnetic material capable of forming a magnetic circuit, such as silicon steel, nickel-iron (Permalloy), cobalt-iron (Permendur), amorphous metal alloys, and ferrites.

Further, according to the magnetic core considering the skin effect of magnetic flux, in order to adapt to different application requirements, the magnetic core internally has a closed or discontinuous duct structure, and has a shape which may be consistent with common magnetic core shapes, such as ring type, CC or UU type, tank type, PQ type, RM type and EE type, as shown in FIGS. 2A-2D.

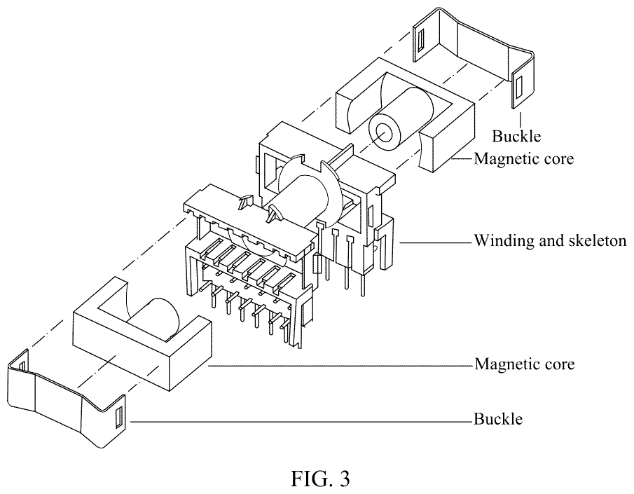

Further, according to the magnetic core considering the skin effect of magnetic flux proposed by the present invention, since a single magnetic core cannot form a closed magnetic circuit, it needs to be combined with other magnetic cores or other media to form a closed magnetic circuit, which closed magnetic circuit as shown in FIG. 3, including a winding and a skeleton, a pair of EC type magnetic cores, and buckles disposed at both ends for securing the magnetic cores. The pair of EC type magnetic cores are connected through the matching skeleton to form a closed magnetic circuit. The winding on the skeleton provides a magnetomotive force to the closed magnetic circuit to form a magnetic flux. The buckles are used to secure the magnetic cores, reduce the air gap between the magnetic cores, and reduce the vibration generated when the magnetic core is operating. Since the magnetic core in the magnetic circuit considers the skin effect of magnetic flux, the closed magnetic circuit has the effect of suppressing the skin effect of magnetic flux.

Based on the above magnetic core considering the skin effect of magnetic flux, the design method for the magnetic core considering the skin effect of magnetic flux proposed by the present invention comprises the following specific processes:
S1. selecting the shape, size and material of the magnetic core according to actual application requirements;
S2. designing a cross-section of the magnetic core through which the magnetic flux flows according to the electromagnetic characteristics, temperature characteristics, magnetic flux amplitude and operating frequency of the magnetic core, to form a multi-connected region;
S3. stretching the cross-section of the magnetic core along the plane of the path for the magnetic flux to flow through the magnetic core, to form a continuous or discontinuous tubular structure inside the magnetic core; and
S4. forming a closed magnetic circuit by the magnetic core or the magnetic core and other media (for example, air), thus forming the magnetic core considering the skin effect of magnetic flux.

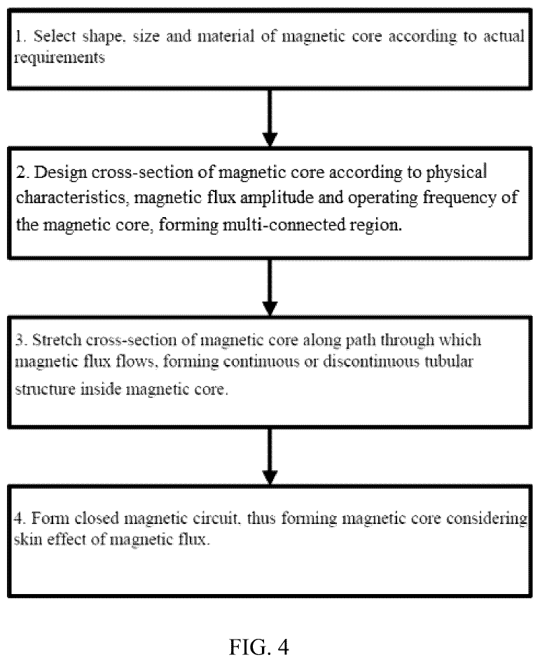

A corresponding flow chart of the design method for the magnetic core considering the skin effect of magnetic flux is shown in FIG. 4. The magnetic core considering the skin effect of magnetic flux and design method thereof proposed by the present invention is verified below.

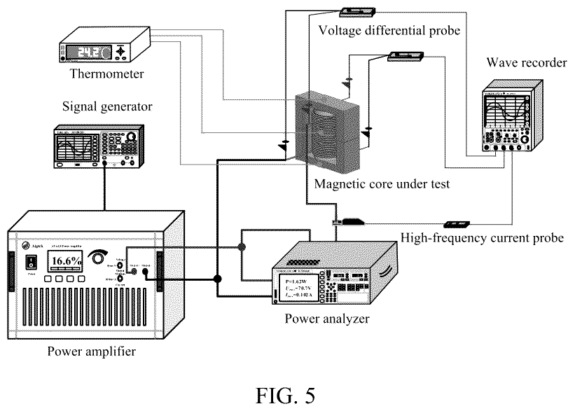

A verification device for the magnetic core considering the skin effect of magnetic flux and the design method thereof is shown in FIG. 5. The verification device consists of a signal generator, a power amplifier, three sets of magnetic cores under test, a power analyzer, a voltage differential probe, a high-frequency current probe and a wave recorder. EC90 magnetic cores were selected for the three sets of magnetic cores under test. The material of the magnetic cores is HP3, and the structure thereof is shown in FIG. 2C. Central columns of the three sets of magnetic cores under test have aperture diameters of 0 mm, 5 mm, and 10 mm, respectively, and weights of 740 g, 723 g, and 680 g, respectively. A primary side of winding of the magnetic core uses Litz wire with a specification of 0.1 mm/100, a number of turns is 25, and a measured direct current resistance is 0.0717 Ω. A secondary side of winding of the magnetic core uses a polyester enamelled copper wire with a diameter of 0.47 mm, a number of turns is 25, and a measured direct current resistance is 0.275 Ω. The primary side and secondary side windings were kept the same during measurement of the three sets of magnetic cores.

Under the condition of an initial magnetic core temperature of 25° C., the magnetic fluxes in the magnetic cores were kept at 0.00018 Wb, and the magnetomotive forces of the three sets of magnetic cores, and magnetic core losses and maximum temperatures of the magnetic cores were continuously tested. According to Ampere's law, the magnetomotive force of the magnetic cores was obtained by multiplying the current measured by the high-frequency current probe and the number of turns. The magnetic core power loss was obtained by deducting the resistance loss of the primary side winding from the input active power measured by the power analyzer. The maximum temperatures of the magnetic cores were directly measured by three sets of thermocouple sensors on the magnetic cores.

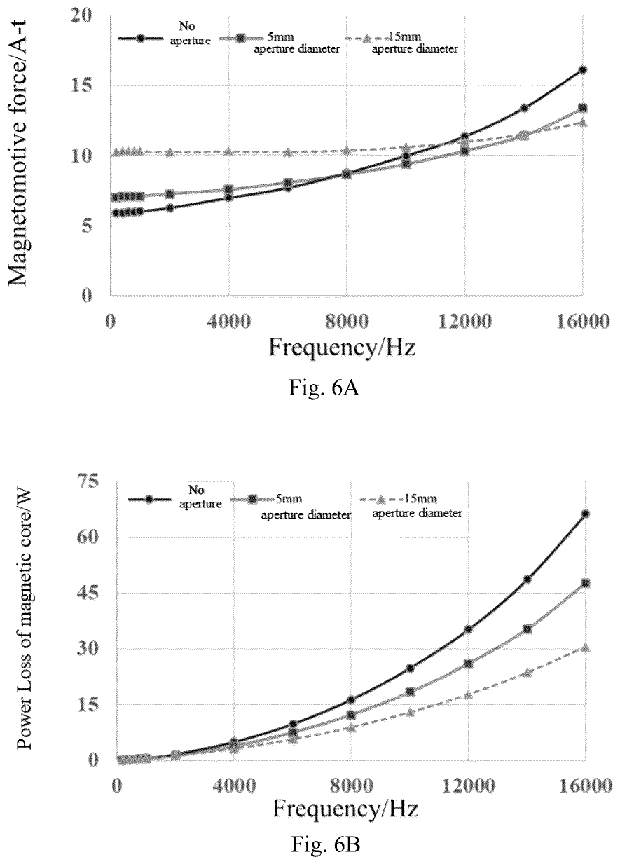

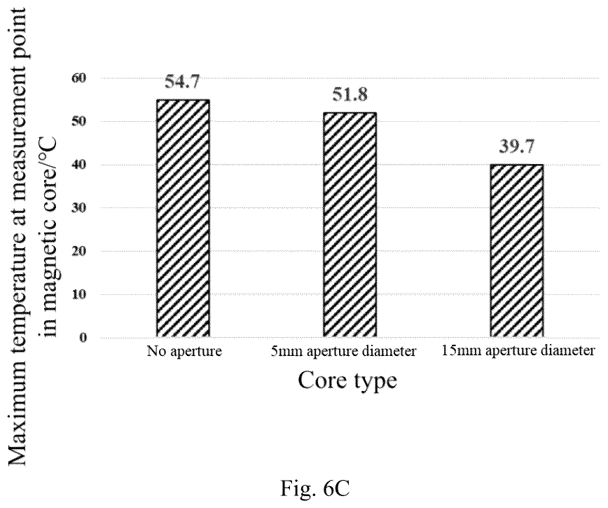

Test results of the three sets of magnetic cores are shown in FIGS. 6A-6C. As shown in FIG. 6A, when the frequency is low, the reluctances of the magnetic cores increase due to the apertures, and the magductances of the magnetic cores do not play a major role. Therefore, for the same magnetic flux to be generated, the required magnetomotive force for a 15 mm aperture magnetic core>the required magnetomotive force for a 10 mm aperture magnetic core>the required magnetomotive force for a no-aperture magnetic core. As the frequency of the magnetic flux increases, the phenomenon of skin effect appears in the magnetic flux. The reluctance values of the three sets of magnetic cores are almost the same, and the magductances play a major role in the magnetic circuit. Therefore, under a high-frequency magnetic flux, the required magnetomotive force for a 15 mm aperture magnetic core<the required magnetomotive force for a 10 mm aperture magnetic core<the required magnetomotive force for a no-aperture magnetic core. This result shows that the proposed magnetic core considering the skin effect of magnetic flux has a smaller magductance value under a high-frequency magnetic flux, which can suppress the skin effect of magnetic flux.

Since the closed magnetic circuit formed by the aperture magnetic core has the closed or discontinuous duct structure, the magnetic core having the tubular structure has a smaller magductance value. Under the same magnetic flux, from the power law of the magnetic circuit P=ω(ω [symbol] Φ²), the magnetic core power loss generated by the 15 mm aperture magnetic core is the smallest, the magnetic core loss generated by the 5 mm aperture magnetic core is larger, and the magnetic core loss generated by the no-aperture magnetic core is the largest. As shown in FIG. 6B, the experimental results verify the correctness of the theoretical analysis.

During the experiment, no heat dissipation or cooling device was used, and therefore, the value of the power loss generated by the magnetic core can also be reflected by the temperature rise of the magnetic core. As shown in FIG. 6C, the temperature rise corresponding to the 15 mm aperture magnetic core is the smallest, the temperature rise of the 5 mm aperture magnetic core is the second, and the temperature rise of the no-aperture magnetic core is the highest, which once again verifies the effectiveness and feasibility of the magnetic core considering the skin effect of magnetic flux proposed by the present invention.

In summary, the present invention proposes a magnetic core considering the skin effect of magnetic flux and a design method thereof. The description above is only preferred embodiments of the present invention, and the scope of protection of the present invention is not limited to the above embodiments. The magnetic core is not limited to ferrites, and all the materials capable of forming the magnetic circuit and equivalent modifications or variations made by those of ordinary skill in the art based on the disclosure of the present invention should be included within the scope of protection described in the claims.

The description above is only a portion of embodiments of the present invention. It should be noted that, several improvements and modifications may be made by those of ordinary skill in the art without departing from the principle of the present invention, and these improvements and modifications should also be considered within the protection scope of the present invention.

What is claimed is:

1. A magnetic core considering the skin effect of magnetic flux, wherein,
the magnetic core has a closed or discontinuous hollow duct structure, and when the outer contour of the magnetic core has been determined, the thickness of the hollow duct in a cross-section of the magnetic core through which the magnetic flux flows is designed according to the electromagnetic characteristics, temperature coefficient, magnetic flux amplitude and operating frequency of the material of the magnetic core, to form the cross-section of the magnetic core characterized by a multi-connected region.

2. The magnetic core considering the skin effect of magnetic flux according to claim 1, wherein the cross-section of the magnetic core is designed into a hollow ring structure, or a radial notch structure, to reduce or block the path of an induced eddy current, that is, to reduce the equivalent magductance of the magnetic circuit.

3. The magnetic core considering the skin effect of magnetic flux according to claim 1, wherein the shape of the closed or discontinuous duct inside the magnetic core is obtained by stretching the cross-section of the magnetic core along the path through which the magnetic flux flows.

4. The magnetic core considering the skin effect of magnetic flux according to claim 1, wherein the thickness of the closed or discontinuous duct inside the magnetic core is determined by the electromagnetic characteristics, temperature coefficient, magnetic flux amplitude and operating frequency of the material of the magnetic core, that is, related to the skin depth
$$δ = \sqrt{\frac{1}{π f μ σ}}$$
of the magnetic flux, in which formula, f is the operating frequency of the magnetic flux in the magnetic core, μ is the temperature-dependent magnetic conductivity of the magnetic core, and σ is the temperature-dependent electrical conductivity of the magnetic core.

5. The magnetic core considering the skin effect of magnetic flux according to claim 1, wherein the closed or discontinuous hollow duct inside the magnetic core is filled with air or other non-magnetic conductive materials.

6. The magnetic core considering the skin effect of magnetic flux according to claim 5, wherein for the magnetic core internally having the continuous duct structure, the duct structure is used as a circulation passage for a cooling medium.

7. The magnetic core considering the skin effect of magnetic flux according to claim 1, wherein the material of the magnetic core is a material capable of forming a magnetic circuit, including silicon steel, nickel-iron, cobalt-iron, amorphous metal alloys, and ferrites.

8. The magnetic core considering the skin effect of magnetic flux according to claim 1, wherein the magnetic core internally has a closed or discontinuous duct structure, and has a shape including ring type, CC or UU type, tank type, PQ type, RM type and EE type.

9. A closed magnetic circuit with the effect of suppressing the skin effect of magnetic flux, wherein the closed magnetic circuit is formed by the magnetic core according to claim 1 together with other magnetic cores or other media.

10. A design method for a magnetic core considering the skin effect of magnetic flux, comprising the following specific steps:
S1. selecting the shape, size and material of the magnetic core according to actual application requirements;
S2. designing a cross-section of the magnetic core through which the magnetic flux flows according to the electromagnetic characteristics, temperature characteristics, magnetic flux amplitude and operating frequency of the magnetic core, to form a multi-connected region;
S3. stretching the cross-section of the magnetic core along the plane of the path for the magnetic flux to flow through the magnetic core, to form a continuous or discontinuous tubular structure inside the magnetic core; and
S4. forming a closed magnetic circuit by the magnetic core or the magnetic core and other media, thus forming the magnetic core considering the skin effect of magnetic flux.
